(19) United States
(12) Patent Application Publication
(10) Pub. No.: US 2026/0259586 A1
(43) Pub. Date: Sep. 3, 2026

(54) ASSISTANCE FOR POWER CLASS REDUCTION

(71) Applicant: Lenovo (United States) Inc., Morrisville, NC (US)

(72) Inventors: John Peter Vitale, Chicago, IL (US); Armin W. Klomsdorf, Chicago, IL (US); John R. Mura, Oakbrook Terrace, IL (US)

(73) Assignee: Lenovo (United States) Inc., Morrisville, NC (US)

(21) Appl. No.: 19/067,404

(22) Filed: Feb. 28, 2025

(51) Int. Cl. G06F 1/20; G06F 1/26

(52) U.S. Cl. CPC G06F 1/206; G06F 1/26

(57) ABSTRACT

Various aspects of the present disclosure relate to assistance for power class reduction. An apparatus, such as a user equipment (UE), determines that one or more of a UE power condition or a UE thermal condition occurs, and transmits a first assistance request for power class reduction based at least in part on one or more of the UE power condition or the UE thermal condition. In aspects of the present disclosure, an apparatus, such as a network equipment (NE), receives a first assistance request for power class reduction based at least in part on one or more of a UE power condition or a UE thermal condition, and performs a power class reduction operation based at least in part on the first assistance request.

### TECHNICAL FIELD

The present disclosure relates to wireless communications, and more specifically to power class control in wireless communications.

### BACKGROUND

A wireless communications system may include one or multiple network communication devices, which may be otherwise known as network equipment (NE), supporting wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers, or the like)). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

### SUMMARY

An article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on”. Further, as used herein, including in the claims, a “set” may include one or more elements.

A UE for wireless communication is described. The UE may be configured to, capable of, or operable to perform one or more operations as described herein. For example, the UE may be configured to, capable of, or operable to transmit a first assistance request for power class reduction based at least in part on one or more of a UE power condition or a UE thermal condition.

A processor (e.g., a standalone processor chipset, or a component of a UE) for wireless communication is described. The processor may be configured to, capable of, or operable to perform one or more operations as described herein. For example, the processor may be configured to, capable of, or operable to transmit a first assistance request for power class reduction based at least in part on one or more of a UE power condition or a UE thermal condition.

A method performed or performable by a UE for wireless communication is described. The method may include transmitting a first assistance request for power class reduction based at least in part on one or more of a UE power condition or a UE thermal condition.

In some implementations of the UE, the processor, and the method described herein, the first assistance request includes UE assistance information (UAI).

In some implementations of the UE, the processor, and the method described herein, the first assistance request is based at least in part on the UE power condition, and the UE power condition is based at least in part on a UE power mode.

In some implementations of the UE, the processor, and the method described herein, the first assistance request is based at least in part on the UE power condition, and the UE power condition is based at least in part on a UE battery level.

In some implementations of the UE, the processor, and the method described herein, the first assistance request is based at least in part on the UE power condition, and the UE power condition is based at least in part on an application power parameter.

In some implementations of the UE, the processor, and the method described herein, the first assistance request is based at least in part on the UE power condition, and the UE power condition is based at least in part on a channel quality.

In some implementations of the UE, the processor, and the method described herein, the first assistance request includes an indication of an uplink parameter associated with power class reduction.

In some implementations of the UE, the processor, and the method described herein, the UE, the processor, and the method may further be configured to, capable of, operable to, performed to, or performable to determine that one or more of the UE power condition or the UE thermal condition occurs; determine that one or more of a channel quality condition or an emergency condition occurs; and prevent transmission of a second assistance request for power class reduction based at least in part on one or more of the channel quality condition or the emergency condition.

In some implementations of the UE, the processor, and the method described herein, the first assistance request is based at least in part on an estimated power reduction value, and wherein the estimated power reduction value is based at least in part on an estimated power output reduction associated with the power class reduction.

In some implementations of the UE, the processor, and the method described herein, the estimated power output reduction is based at least in part on an estimated uplink power output reduction.

In some implementations of the UE, the processor, and the method described herein, the estimated power reduction value is based at least in part on a battery level value.

In some implementations of the UE, the processor, and the method described herein, the first assistance request is based at least in part on the UE thermal condition, and wherein the UE thermal condition includes one or more thermal thresholds.

In some implementations of the UE, the processor, and the method described herein, the first assistance request is based at least in part on the UE thermal condition, and the UE thermal condition is based at least in part on an application power parameter.

In some implementations of the UE, the processor, and the method described herein, the first assistance request is based at least in part on an estimated thermal reduction value, and wherein the estimated thermal reduction value is based at least in part on the power class reduction.

In some implementations of the UE, the processor, and the method described herein, the estimated thermal reduction value is based at least in part on an estimated reduction in uplink operation or an estimated reduction in downlink operation.

In some implementations of the UE, the processor, and the method described herein, the UE, the processor, and the method may further be configured to, capable of, operable to, performed to, or performable to generate the first assistance request via a machine learning algorithm trained with one or more of UE power condition data or UE thermal condition data.

In some implementations of the UE, the processor, and the method described herein, the first assistance request is selected from multiple candidate assistance requests identified by the machine learning algorithm.

An NE (e.g., a base station) for wireless communication is described. The NE may be configured to, capable of, or operable to perform one or more operations as described herein. For example, the NE may be configured to, capable of, or operable to receive a first assistance request for power class reduction based at least in part on one or more of a UE power condition or a UE thermal condition; and perform a power class reduction operation based at least in part on the first assistance request.

A processor (e.g., a standalone processor chipset, or a component of a NE) for wireless communication is described. The processor may be configured to, capable of, or operable to perform one or more operations as described herein. For example, the processor may be configured to, capable of, or operable to receive a first assistance request for power class reduction based at least in part on one or more of a UE power condition or a UE thermal condition; and perform a power class reduction operation based at least in part on the first assistance request.

A method performed or performable by an NE (e.g., a base station) for wireless communication is described. The method may include receiving a first assistance request for power class reduction based at least in part on one or more of a UE power condition or a UE thermal condition; and performing a power class reduction operation based at least in part on the first assistance request.

In some implementations of the NE, the processor, and the method described herein, the first assistance request includes UE assistance information (UAI).

In some implementations of the NE, the processor, and the method described herein, the first assistance request includes an indication of an uplink parameter associated with power class reduction.

### BRIEF DESCRIPTION OF THE DRAWINGS

FIG. 1 illustrates an example of a wireless communications system in accordance with aspects of the present disclosure.

FIG. 2 illustrates an example system in accordance with aspects of the present disclosure.

FIG. 3 illustrates an example flow chart of a method for a power condition in accordance with aspects of the present disclosure.

FIGS. 4-7 illustrate example tables in accordance with aspects of the present disclosure.

FIG. 8 illustrates an example flow chart of a method for a thermal condition in accordance with aspects of the present disclosure.

FIGS. 9-12 illustrate example tables in accordance with aspects of the present disclosure.

FIG. 13 illustrates an example of a UE in accordance with aspects of the present disclosure.

FIG. 14 illustrates an example of a processor in accordance with aspects of the present disclosure.

FIG. 15 illustrates an example of an NE in accordance with aspects of the present disclosure.

FIG. 16 illustrates a flowchart of a method in accordance with aspects of the present disclosure.

FIG. 17 illustrates a flowchart of a method in accordance with aspects of the present disclosure.

### DETAILED DESCRIPTION

In a wireless communications system, a UE and an NE (e.g., a base station, gNB) may support wireless communication (e.g., reception and/or transmission of wireless communication) using time-frequency resources. As part of using time-frequency resources, UEs can support different power classes for wireless communication. Power classes can represent different levels of transmit power that a UE can use for data transmission, and higher power classes may support improved signal strength and extended range in comparison with lower power classes. Higher power classes can also utilize dual active transmit modes, and employ multiple transmit chains to achieve increased output power levels.

While dual transmit configurations can increase wireless coverage and network performance, such configurations can also present challenges related to power consumption and thermal management in UEs. Operating multiple transmit chains simultaneously may cause higher current draw and increased heat generation compared to single transmit configurations, which can impact battery life and potentially lead to thermal constraints in UEs. To address power and thermal issues that may occur in higher power classes, UEs may implement various mitigation techniques, which can include reducing transmit power, adjusting bandwidth allocation, or modifying antenna configurations. However, such mitigation techniques may be performed autonomously by a UE and may not align with network configurations or optimize overall system performance.

Some wireless communications systems utilize communication protocols between UEs and wireless networks (e.g., NEs) to enable more accurate and coordinated management of UE capabilities and network resources. Such protocols can attempt to balance the goals of maximizing radio link performance, optimizing battery life, and maintaining safe operating temperatures across a diverse range of usage scenarios and environmental conditions. Some wireless communication systems use UAI information elements to enable UEs to request network assistance.

Aspects of the present disclosure are described in the context of a wireless communications system, and include implementations that provide a power class UAI for UEs to indicate to NEs an indication of power class (e.g., power class reduction) to reduce power (e.g., current) consumption or reduce heat production at the UEs. In implementations, a UE can use different UE state information to determine UAI to communicate in power saving scenarios, such as UE power modes (e.g., a battery saver mode, user selected power saving modes), battery state (e.g., low battery charge conditions), application parameters for UL and DL, emergency-related communications, etc. Based on such UE state information, a UE can communicate UAI to an NE to request assistance associated with power saving, such as UAI requesting power class reduction or other power reductions that may assist the UE in reducing UE power output.

In implementations, a UE can use different UE state information to determine UAI to communicate in thermal mitigation scenarios, such as based on UE skin temperature, application parameters for UL and DL, emergency-related communications, etc. UE skin temperature can refer to the temperature of an outer surface of a UE, such as an outer surface of a UE chassis and/or a UE case. Based on such UE state information, a UE can communicate UAI to an NE to request assistance associated with thermal mitigation, such as UAI requesting power class reduction or other power reductions that may assist the UE in reducing UE temperature.

By performing the described techniques, a device in a wireless communications system (e.g., a UE) can reduce power consumption and reduce heat output, which can conserve battery life and prevent user discomfort and/or injury due to excessive device heat output.

Reference is made herein to communicating data or information, such as signaling communication resources and/or communications that are transmitted or received between devices. It is to be appreciated that other terms may be used interchangeably with communicating, such as signaling, transmitting, receiving, outputting, forwarding, retrieving, obtaining, and so forth.

Aspects of the present disclosure are described in the context of a wireless communications system.

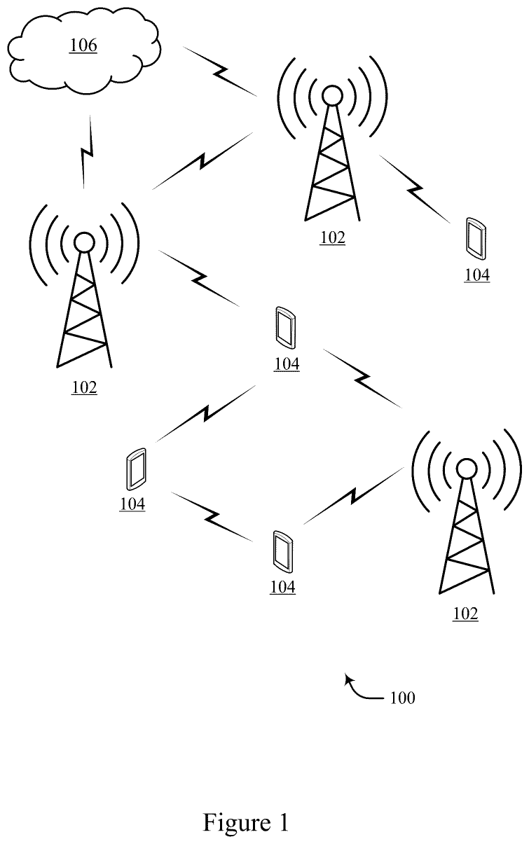

FIG. 1 illustrates an example of a wireless communications system 100 in accordance with aspects of the present disclosure. The wireless communications system 100 may include one or more NEs 102, one or more UEs 104, and a core network (CN) 106. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a NR network, such as a 5G network, a 5G-Advanced (5G-A) network, or a 5G ultrawideband (5G-UWB) network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G, for example, 6G. Additionally, the wireless communications system 100 may support technologies, such as time division multiple access (TDMA), frequency division multiple access (FDMA), or code division multiple access (CDMA), etc.

The one or more NEs 102 may be dispersed throughout a geographic region to form the wireless communications system 100. One or more of the NEs 102 described herein may be or include or may be referred to as a network node, a base station, an access point (AP), a network element, a network function, a network entity, a radio access network (RAN), a NodeB, an eNodeB (eNB), a next-generation NodeB (gNB), or other suitable terminology. An NE 102 and a UE 104 may communicate via a communication link, which may be a wireless or wired connection. For example, an NE 102 and a UE 104 may perform wireless communication (e.g., receive signaling, transmit signaling) over a Uu interface.

An NE 102 may provide a geographic coverage area for which the NE 102 may support services for one or more UEs 104 within the geographic coverage area. For example, an NE 102 and a UE 104 may support wireless communication of signals related to services (e.g., voice, video, packet data, messaging, broadcast, etc.) according to one or multiple radio access technologies. In some implementations, an NE 102 may be moveable, for example, a satellite associated with a non-terrestrial network (NTN). In some implementations, different geographic coverage areas associated with the same or different radio access technologies may overlap, but the different geographic coverage areas may be associated with different NE 102.

The one or more UEs 104 may be dispersed throughout a geographic region of the wireless communications system 100. A UE 104 may include or may be referred to as a remote unit, a mobile device, a wireless device, a remote device, a subscriber device, a transmitter device, a receiver device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples.

A UE 104 may be able to support wireless communication directly with other UEs 104 over a communication link. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link may be referred to as a sidelink. For example, a UE 104 may support wireless communication directly with another UE 104 over a PC5 interface.

An NE 102 may support communications with the CN 106, or with another NE 102, or both. For example, an NE 102 may interface with other NE 102 or the CN 106 through one or more backhaul links (e.g., S1, N2, N6, or other network interface). In some implementations, the NE 102 may communicate with each other directly. In some other implementations, the NE 102 may communicate with each other indirectly (e.g., via the CN 106). In some implementations, one or more NEs 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

The CN 106 may support user authentication, access authorization, tracking, connectivity, and other access, routing, or mobility functions. The CN 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a packet data network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more NEs 102 associated with the CN 106.

The CN 106 may communicate with a packet data network over one or more backhaul links (e.g., via an S1, N2, N6, or other network interface). The packet data network may include an application server. In some implementations, one or more UEs 104 may communicate with the application server. A UE 104 may establish a session (e.g., a protocol data unit (PDU) session, or the like) with the CN 106 via an NE 102. The CN 106 may route traffic (e.g., control information, data, and the like) between the UE 104 and the application server using the established session (e.g., the established PDU session). The PDU session may be an example of a logical connection between the UE 104 and the CN 106 (e.g., one or more network functions of the CN 106).

In the wireless communications system 100, the NEs 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the NEs 102 and the UEs 104 may support different resource structures. For example, the NEs 102 and the UEs 104 may support different frame structures. In some implementations, such as in 4G, the NEs 102 and the UEs 104 may support a single frame structure. In some other implementations, such as in 5G and among other suitable radio access technologies, the NEs 102 and the UEs 104 may support various frame structures (i.e., multiple frame structures). The NEs 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally, or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0, μ=1, μ=2, μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., OFDM symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHz), FR2 (24.25 GHz-52.6 GHz), FR3 (7.125 GHz-24.25 GHz), FR4 (52.6 GHz-114.25 GHz), FR4a or FR4-1 (52.6 GHz-71 GHz), and FR5 (114.25 GHz-300 GHz). In some implementations, the NEs 102 and the UEs 104 may perform wireless communications over one or more of the operating frequency bands. In some implementations, FR1 may be used by the NEs 102 and the UEs 104, among other equipment or devices for cellular communications traffic (e.g., control information, data). In some implementations, FR2 may be used by the NEs 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

According to implementations, one or more of the NEs 102 and the UEs 104 are operable to implement various aspects of the techniques described with reference to the present disclosure. For example, a UE 104 determines that one or more of a UE power condition or a UE thermal condition occurs, and transmits to an NE 102 a first assistance request for power class reduction based at least in part on one or more of the UE power condition or the UE thermal condition. The first assistance request may request a reduction in a maximum power class used by the NE 102 for wireless communication with the UE 104.

An NE 102 (e.g., a base station, gNB) receives, from a UE 104, a first assistance request for power class reduction based at least in part on one or more of a UE power condition or a UE thermal condition, and performs a power class reduction operation based at least in part on the first assistance request. The power class reduction operation can include reducing, by the NE 102, a maximum power class used by the NE 102 for wireless communication with the UE 104.

Reference is made herein to communicating data or information, such as signaling communication resources and/or communications that are transmitted or received between devices. It is to be appreciated that other terms may be used interchangeably with communicating, such as signaling, transmitting, receiving, outputting, forwarding, retrieving, obtaining, and so forth.

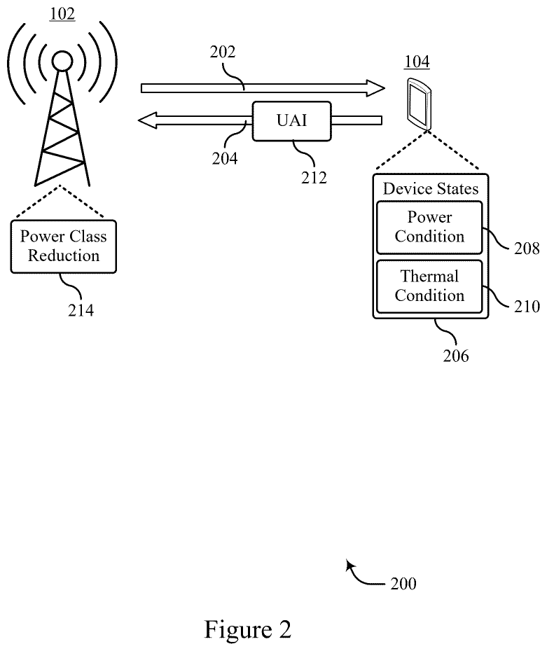

FIG. 2 illustrates an example system 200 in accordance with aspects of the present disclosure. The system 200 includes one or more downlink channels 202 and one or more uplink channels 204 available for wireless communication between an NE 102 and a UE 104. The UE 104 can monitor various device states 206, such as power states, thermal states (e.g., UE temperature), etc. In implementations, the UE 104 may detect a power condition 208 where the UE 104 may request assistance to reduce power (e.g., current) consumption of the UE 104. In an example, the power condition 208 can include activation of a power saving mode at the UE 104. A user and/or device functionality, for example, can trigger a power saving mode of the UE 104, such as a battery conservation mode (e.g., “Eco” mode), a battery saver mode, etc. As another example, the power condition 208 can be based on a low battery level of the UE 104, e.g., a battery level below a battery charge threshold.

Based on the power condition 208, the UE 104 can communicate (transmit, send) a UAI 212 to the NE 102 requesting one or more power reduction procedures, e.g., a power class reduction. As further detailed herein, the UAI 212 may include a specific power class reduction, such as power class reduction associated with uplink communication from the UE 104 to the NE 102. Some conditions may occur where the UE 104 does not request power class reduction based on the power condition 208, such as where the UE 104 performs an emergency communication (e.g., an emergency call, an emergency message), where an application of the UE 104 specifies an UL parameter (e.g., a minimum UL throughput for the UE) for uplink transmission by the UE 104, or where an application of the UE 104 specifies a DL parameter, e.g., a minimum DL throughput for the UE.

In implementations, the UE 104 may detect a thermal condition 210, such as based on a temperature (e.g., a skin temperature) of the UE 104 meeting (e.g., exceeding) a temperature threshold. The thermal condition 210, for example, can occur when the skin temperature of the UE 104 meets a minimum temperature threshold for initiating thermal mitigation, but does not meet a critical temperature threshold for device safety. Based on the thermal condition 210, the UE 104 can communicate (transmit, send) a UAI 212 to the NE 102 requesting one or more power reduction procedures, e.g., a power class reduction. As further detailed herein, and based on the thermal condition 210, the UAI 212 may include specific power class reduction, such as power class reduction associated with uplink communication from the UE 104 to the NE 102 and/or power class reduction associated with downlink communication from the NE 102 to the UE 104. Some conditions may occur where the UE 104 does not request power class reduction based on the thermal condition 210, such as where the UE 104 performs an emergency communication (e.g., an emergency call, an emergency message), where an application of the UE 104 specifies a particular uplink parameter (e.g., a minimum uplink throughput) for uplink transmission by the UE 104, or where an application of the UE 104 specifies a DL parameter, e.g., a minimum DL throughput for the UE.

Where the UE 104 communicates the UAI 212 to the NE 102 requesting power class reduction, the NE 102 may perform power class reduction 214 for wireless communication with the UE 104. The power class reduction 214, for example, may be applied to downlink communication over the one or more downlink channels 202 and/or uplink communication over the one or more uplink channels 204.

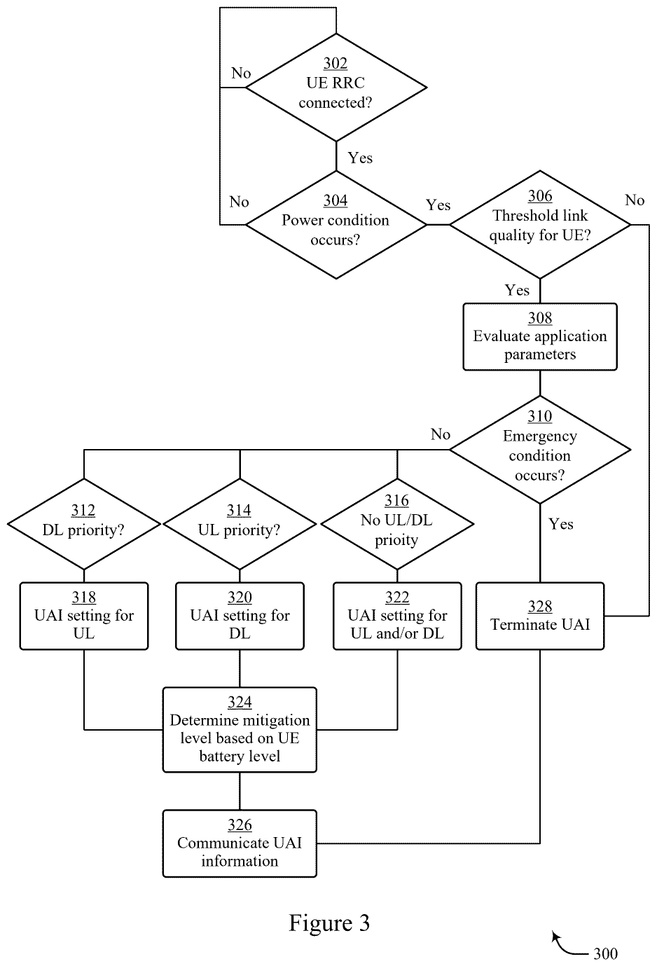

FIG. 3 illustrates an example flow chart of a method 300 for a power condition in accordance with aspects of the present disclosure. At 302, the method may include determining whether a UE is in a radio resource control (RRC) connected state. If the UE is not in an RRC connected state (“No”), the method returns to 302. If the UE is in an RRC connected state (“Yes”), at 304 the method may include determining whether a power condition occurs. If the power condition occurs (“Yes”), at 306 the method may include determining whether a link quality of the UE meets a threshold link quality. The threshold link quality may be measured in various ways, such as received signal strength indication (RSSI), signal-to-noise ratio (SNR), signal-to-interference-plus-noise ratio (SINR), etc. If the link quality of the UE meets the threshold link quality (“Yes”), at 308 the method may include evaluating application parameters. The application parameters, for example, may specify a minimum UL throughput and/or a minimum DL throughput associated with the UE.

At 310, the method may include determining whether an emergency condition occurs. The emergency condition may include an indication that an emergency-related communication is being performed or is to be performed. If an emergency condition does not occur (“No”), and based on the evaluated application parameters, at 312 the method may include determining if DL is indicated as a priority, at 314 the method may include determining whether UL is indicated as a priority, and at 316 the method may include determining whether neither DL nor UL are indicated as a priority. If at 312 DL is indicated as a priority, at 318 the method may include configuring a UAI setting to for power reduction associated with DL communication. If at 314 UL is indicated as a priority, at 320 the method may include configuring a UAI setting for power reduction associated with DL communication. In an example at 320, the UAI setting may be configured to indicate power class reduction for UL communication. If at 316 neither UL nor DL are indicated as a priority, at 322 the method may include configuring a UAI setting for power reduction for either or both of UL communication or DL communication.

At 324, the method may include determining a mitigation level based on UE battery level. The mitigation level may specify whether power class reduction is to be applied to UL, DL, or both UL and DL. For example, where UE battery level is below a threshold, multiple mitigation levels may be applied. At 326, the method may include communicating UAI information. The UE may communicate the UAI information to a NE. In implementations, the UAI information may request power reduction for UL and/or DL. The UAI may include a request for power class reduction based on the determined mitigation level and may request power class reduction for UL.

In the method 300, if at 304 a power condition does not occur (“No”), the method may return to 302. If at 306 the link quality of the UE does not meet the threshold link quality (“No”), at 328 the method may include terminating UAI and at 326 communicating UAI information to stop power reduction for the UE, e.g., power class reduction. If at 310 an emergency condition occurs (“Yes”), at 328 the method may include terminating UAI and at 326 communicating UAI information to stop power reduction associated with the UE, e.g., power class reduction for the UE.

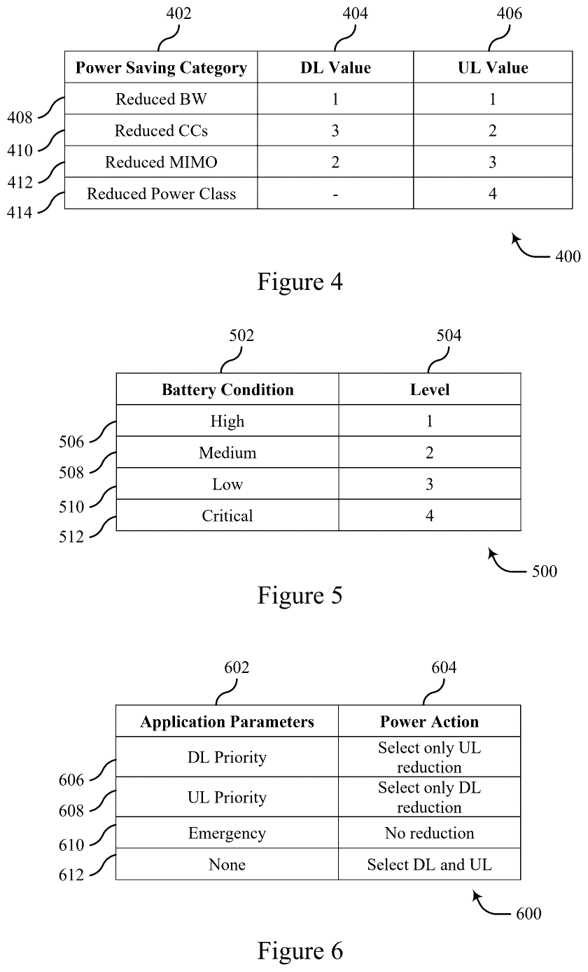

FIG. 4 illustrates an example table 400 in accordance with aspects of the present disclosure. The table 400 includes a power saving category column 402, a DL value column 404, and an UL value column 406. The power saving category column 402 includes different techniques for enabling UE power saving. The DL value column 404 includes a DL value for a respective power saving category identified in the power saving category column 402, and the UL value column 406 includes an UL value for a respective power saving category identified in the power saving category column 402. The values in the DL value column 404 and the UL value column 406 are based on an ascending value scale, with a value of 1 having a low impact on UE power saving and a value of 4 having a high impact on power saving.

The table 400 includes: a row 408 representing reduction in bandwidth (BW), with a DL value of 1 and an UL value of 1; a row 410 representing a reduction in component carriers (CCs), with a DL value of 3 and an UL value of 2; a row 412 representing reduced MIMO (e.g., a reduction in a number of MIMO layers utilized), with a DL value of 2 and an UL value of 3; and a row 414 representing a reduced power class with no DL value (e.g., no effect on UE power savings) and an UL value of 4, e.g., a high impact on UE power savings.

FIG. 5 illustrates an example table 500 in accordance with aspects of the present disclosure. The table 500 includes a battery condition column 502 and a battery level column 504. The battery condition column 502 identifies different battery charge levels for a UE battery, and the battery level column 504 identifies battery level values that correspond to respective battery conditions. The table 500 includes: a row 506 representing a high battery condition (e.g., fully charged), with a battery level of 1; a row 508 representing a medium battery condition with a battery level of 2; a row 510 representing a low battery condition with a battery level of 3; and a row 512 representing a critical battery condition (e.g., battery charge is almost depleted) with a battery level of 4.

FIG. 6 illustrates an example table 600 in accordance with aspects of the present disclosure. The table 600 includes an application parameters column 602 and a UAI power actions column 604. The application parameters column 602 includes different communication priorities for different applications, and the UAI power actions column 604 includes example power-related actions that can be performed. The table 600 includes: a row 606 representing an application parameter where DL has priority, and where a power action can be a reduction in UL power; a row 608 where an application parameter is UL has priority, and where a power action can be a reduction in DL power; a row 610 for emergency conditions where no power reduction is to be applied; and a row 612 where DL priority, UL priority, and emergency condition do not apply, and a power action of one or both of DL or UL power reduction can be applied.

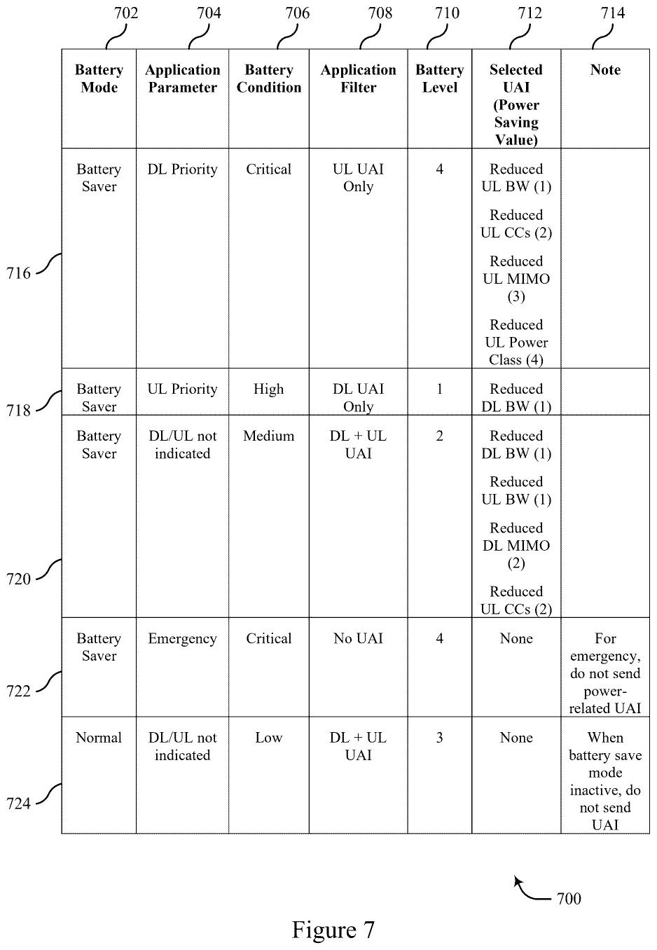

FIG. 7 illustrates an example table 700 in accordance with aspects of the present disclosure. The table 700 illustrates different UE operating scenarios, and can be populated with information from the tables 400-600 for the different UE operating scenarios. The table 700 includes a battery mode column 702, an application parameter column 704, a battery condition column 706, an application filter column 708, a battery level column 710, a selected UAI column 712, and a notes column 714. The battery mode column 702 can indicate different battery modes (e.g., power modes), such as a power saver mode where battery output is to be reduced, and a normal mode where battery output reduction is not applied. The application parameter column 704 can include different application parameters, such as described with reference to the application parameters column 602 of the table 600. The battery condition column 706 can include different battery condition states, such as described with reference to the battery condition column 502 of the table 500. The application filter column 708 can include different application UAI filters that can be applied based on application parameters of the application parameter column 704. The battery level column 710 can include different battery level values, such as described with reference to the battery level column 504 of the table 500. The selected UAI column 712 can include different UAI types that can be selected based on state information from the columns 702-710, and a respective power saving value for each UAI type. The power saving values, for instance, can be based on the DL values of the DL value column 404 and/or the UL values of the UL value column 406 of the table 400. The notes column 714 can include relevant information for state information included in the columns 702-710.

The table 700 includes a row 716 where a battery saver mode is active, an application parameter indicates that DL has priority, battery condition is critical, an application filter indicates that an UL UAI is to be sent, and battery level is 4. For the row 716, the selected UAI column 712 includes different options for power reduction UAI that can be communicated by a UE. For instance, a reduced UL BW UAI may have a power saving value of 1, e.g., a low power saving. A reduced UL CCs UAI may have a power saving value of 2, a reduced UL MIMO may have a power saving value of 3, and a reduced UL power class may have a power saving value of 4. The rows 718, 720 also indicate different UE states and different UAI options in the selected UAI column 712. A row 722 indicates that a batter saver mode is active, an application parameter of an emergency condition, a critical battery level, an application filter of no UAI, and a battery level of 4. For the row 722, the selected UAI column 712 indicates that no power-related UAI is to be communicated by the UE, and the notes column 714 indicates that for emergency conditions, no power-related UAI are to be communicated. A row 724 indicates a normal battery mode (e.g., that a battery saver mode is not active), that no application parameter is determined (e.g., no priority indicated for DL or UL), a low battery condition, an application filter indicating that DL and UL UAI may be applied for an application, and a battery level of 3. For the row 724, the selected UAI column 712 indicates that no power saving UAI is to be communicated, e.g., based on the normal battery mode. The notes column 714 indicates that when a battery saver mode of the UE is not active, UAI for power saving is not to be communicated. In implementations, the tables 400-700 can be used to perform various operations for power saving, such as with reference to the method 300.

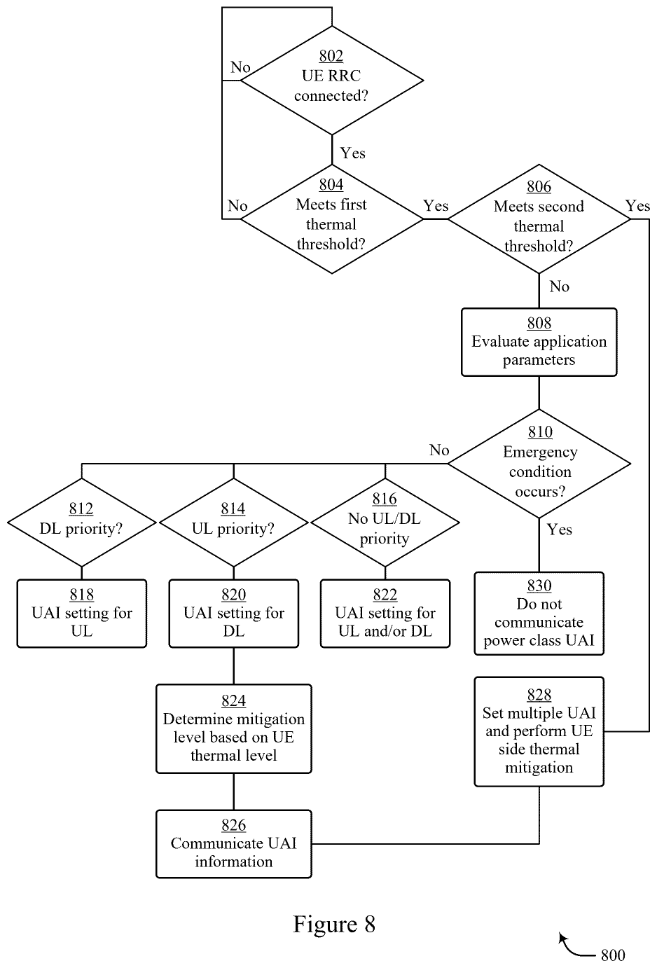

FIG. 8 illustrates an example flow chart of a method 800 for a thermal condition in accordance with aspects of the present disclosure. At 802, the method may include determining whether a UE is in an RRC connected state. If the UE is not in an RRC connected state (“No”), the method returns to 802. If the UE is in an RRC connected state (“Yes”), at 804 the method may include determining whether the UE meets a first thermal threshold. The first thermal threshold may represent a first UE skin temperature threshold. If the UE meets the first thermal threshold (“Yes”), at 806 the method may include determining whether the UE meets a second thermal threshold. The second thermal threshold may represent a higher temperature value than the first thermal threshold, e.g., a critical UE skin temperature threshold. If at 806 the UE does not meet the second thermal threshold (e.g., is below the second thermal threshold) (“Yes”), at 808 the method may include evaluating application parameters. The application parameters, for example, may specify a minimum UL throughput and/or a minimum DL throughput associated with the UE.

At 810, the method may include determining whether an emergency condition occurs. The emergency condition may include an indication that an emergency-related communication is being performed or is to be performed. If an emergency condition does not occur (“No”), and based on the evaluated application parameters, at 812 the method may include determining if DL is indicated as a priority, at 814 the method may include determining whether UL is indicated as a priority, and at 816 the method may include determining whether neither DL nor UL are indicated as a priority. If at 812 DL is indicated as a priority, at 818 the method may include configuring a UAI setting to indicate power class reduction for UL communication. If at 814 UL is indicated as a priority, at 820 the method may include configuring a UAI setting to indicate power class reduction for DL communication. If at 816 neither UL nor DL are indicated as a priority, at 822 the method may include configuring a UAI setting for either or both of UL communication or DL communication.

At 824, the method may include determining a mitigation level based on UE thermal level. The mitigation level may specify whether power class reduction is to be applied to UL, DL, or both UL and DL. At 826 the method may include communicating UAI information. The UE may communicate the UAI information to a NE. In implementations, the UAI information may request power class reduction. The UAI for power class reduction may be based on the determined mitigation level and may request power class reduction for UL.

In the method 800, if at 804 the UE does not meet the first thermal threshold (“No”), the method may return to 802. If at 806 the UE meets the second thermal threshold (e.g., is above the second thermal threshold, e.g., a critical skin temperature) (“No”), at 828 the method may include setting multiple UAIs for power reduction and performing UE side thermal mitigation. The multiple UAIs, for example, may be selected from reducing UL and/or DL BW, reducing UL and/or DL CCs, reducing UL and/or DL MIMO, reducing UL and/or DL power class, etc. Further, the UE side thermal mitigation can include operations such as power output backoff by the UE, UE processor throttling, UE application throttling, etc. At 826, where multiple UAIs are set at 828, communicating the UAI information can include information of the multiple UAIs. In the method 800, if at 810 an emergency condition occurs (“Yes”), at 830 a power class UAI is not communicated. In implementations, when an emergency condition occurs, no power class reduction UAI is communicated to a NE.

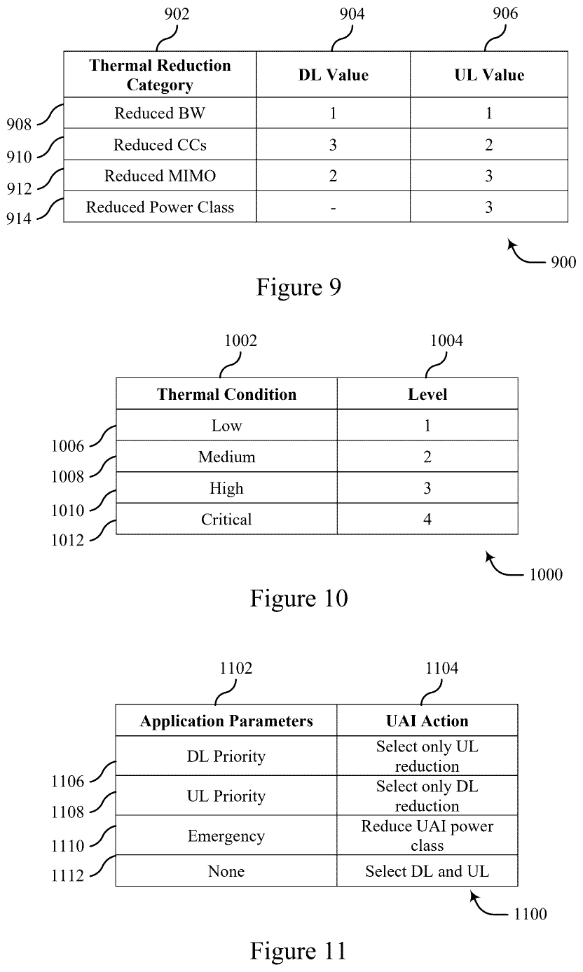

FIG. 9 illustrates an example table 900 in accordance with aspects of the present disclosure. The table 900 includes a thermal reduction category column 902, a DL value column 904, and an UL value column 906. The thermal reduction category column 902 includes different techniques for enabling UE thermal reduction. The DL value column 904 includes a DL value for a respective thermal reduction category identified in the thermal reduction category column 902, and the UL value column 906 includes an UL value for a respective thermal reduction category identified in the thermal reduction category column 902. The values in the DL value column 904 and the UL value column 906 are based on an ascending value scale, with a value of 1 having a low impact on UE thermal reduction and a value of 4 having a high impact on UE thermal reduction.

The table 900 includes: a row 908 representing reduction in BW, with a DL value of 1 and an UL value of 1; a row 910 representing a reduction in CCs, with a DL value of 3 and an uplink value of 2; a row 912 representing reduced MIMO (e.g., a reduction in a number of MIMO layers utilized), with a DL value of 2 and an UL value of 3; and a row 914 representing a reduced power class with no DL value (e.g., no effect on UE thermal reduction) and an UL value of 3, e.g., a high impact on UE thermal reduction.

FIG. 10 illustrates an example table 1000 in accordance with aspects of the present disclosure. The table 1000 includes a thermal condition column 1002 and a thermal level column 1004. The thermal condition column 1002 identifies different thermal conditions for a UE, and the thermal level column 1004 identifies thermal level values that correspond to respective thermal conditions. The table 1000 includes: a row 1006 representing a low thermal condition (e.g., a low UE temperature), with a thermal level of 1; a row 1008 representing a medium thermal condition (e.g., a UE temperature higher than the low thermal condition), with a thermal level of 2; a row 1010 representing a high thermal condition (e.g., a UE temperature higher than the medium thermal condition), with a thermal level of 3; and a row 1012 representing a critical thermal condition (e.g., a UE temperature higher than the high thermal condition), with a thermal level of 4.

FIG. 11 illustrates an example table 1100 in accordance with aspects of the present disclosure. The table 1100 includes an application parameters column 1102 and a UAI actions column 1104. The application parameters column 1102 includes different communication priorities for different applications, and the UAI actions column 1104 includes example thermal mitigation-related actions that can be performed. The table 1100 includes: a row 1106 representing an application parameter where DL has priority, and where a thermal mitigation action can be a reduction in UL power; a row 1108 representing an application parameter where UL has priority, and where a thermal mitigation action can be a reduction in DL power; a row 1110 for emergency conditions where a UAI for power class reduction is not to be communicated; and a row 1112 where DL priority, UL priority, and an emergency condition do not apply, and a thermal mitigation action of one or both of DL or UL power reduction can be applied.

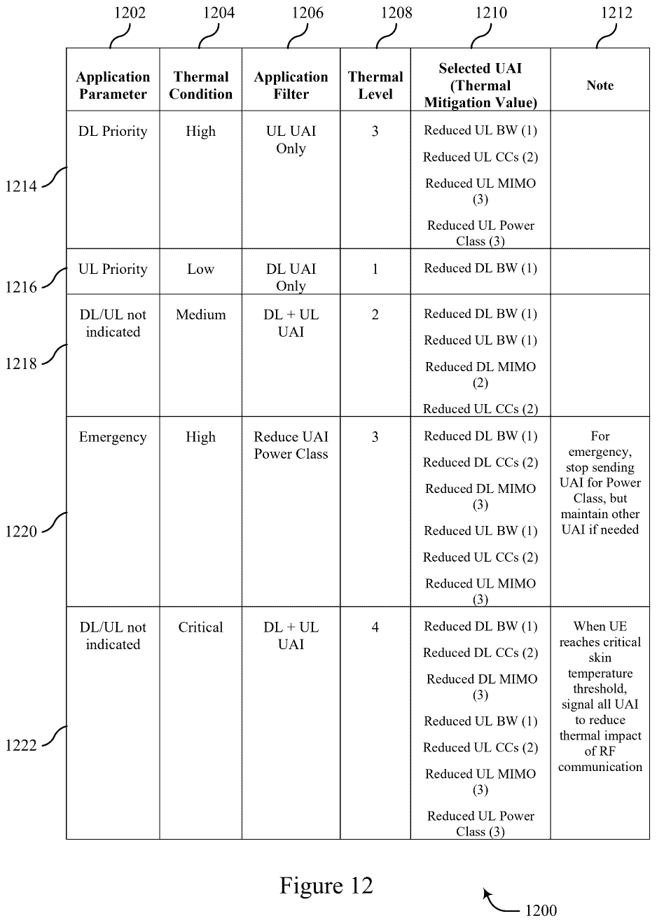

FIG. 12 illustrates an example table 1200 in accordance with aspects of the present disclosure. The table 1200 illustrates different UE operating scenarios, and can be populated with information from the tables 900-1100 for the different UE operating scenarios. The table 1200 includes an application parameter column 1202, a thermal condition column 1204, an application filter column 1206, a thermal level column 1208, a selected UAI column 1210, and a notes column 1212. The application parameter column 1202 can include different application parameters, such as described with reference to the application parameters column 1102 of the table 1100. The thermal condition column 1204 can include different UE thermal condition states, such as described with reference to the thermal condition column 1002 of the table 1000. The application filter column 1206 can include different application UAI filters that can be applied based on application parameters of the application parameter column 704. The thermal level column 1208 can include different thermal level values, such as described with reference to the thermal level column 1004 of the table 1000. The selected UAI column 1210 can include different UAI types that can be selected based on state information from the columns 1202-1208, and a respective thermal mitigation value for each UAI type. The thermal mitigation values, for instance, can be based on the DL values of the DL value column 904 and/or the UL values of the UL value column 906 of the table 900. The notes column 1212 can include relevant information for state information included in the columns 1202-1210.

The table 1200 includes a row 1214 with an application parameter of DL priority, a thermal condition of high, an application filter of UL UAI only, and a thermal level of 3. For the row 1214, the selected UAI column 1210 includes different options for thermal mitigation UAI that can be communicated by a UE. For instance, a reduced UL BW UAI may have a thermal mitigation value of 1; a reduced UL CCs UAI may have a thermal mitigation value of 2; a reduced UL MIMO UAI may have a thermal mitigation value of 3; and a reduced UL power class UAI may have a thermal mitigation value of 3. The rows 1216, 1218 also indicate different UE thermal states and different UAI options in the selected UAI column 1210. A row 1220 indicates an emergency condition, a high thermal condition, a reduce UAI power class application filter, and a thermal level of 3. The selected UAI column 1210 includes different UAI options for the row 1220 and respective thermal mitigation values. The notes column 1212 indicates for the row 1220 that for an emergency condition, UAI are not to be send for power class thermal mitigation, but other UAI (examples of which are described throughout this disclosure) may be communicated. A row 1222 indicates an application parameter of DL/UL not indicated, a thermal condition of critical, an application filter of DL and UL UAI, and a thermal level of 4. The selected UAI column 1210 includes different UAI options for the row 1222 and respective thermal mitigation values. The notes column 1212 indicates for the row 1222 that when a UE reaches a critical temperature threshold (e.g., a critical skin temperature), multiple UAI can be communicated to reduce a thermal impact of RF communication of the UE.

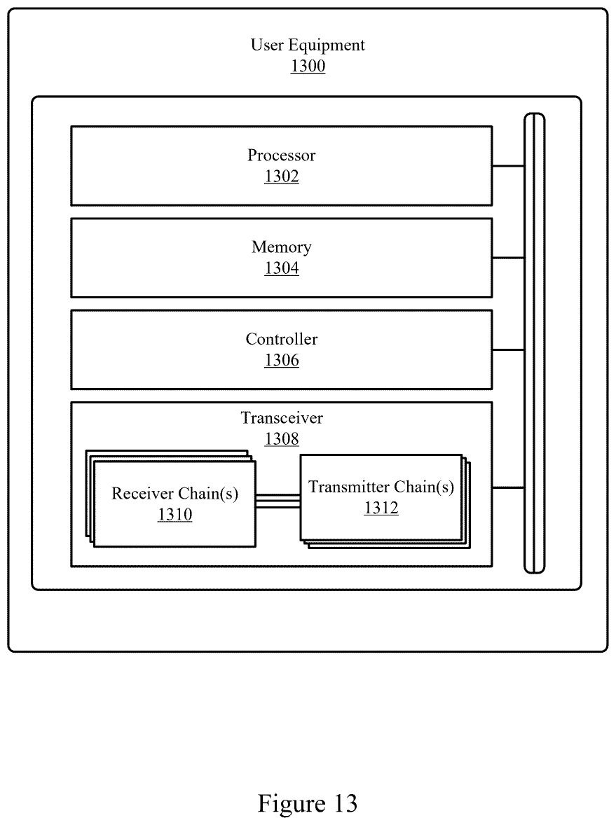

FIG. 13 illustrates an example of a UE 1300 in accordance with aspects of the present disclosure. The UE 1300 may include a processor 1302, a memory 1304, a controller 1306, and a transceiver 1308. The processor 1302, the memory 1304, the controller 1306, or the transceiver 1308, or various combinations thereof or various components thereof may be examples of means for performing various aspects of the present disclosure as described herein. These components may be coupled (e.g., operatively, communicatively, functionally, electronically, electrically) via one or more interfaces.

The processor 1302, the memory 1304, the controller 1306, or the transceiver 1308, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 1302 may include an intelligent hardware device (e.g., a general-purpose processor, a DSP, a CPU, an ASIC, an FPGA, or any combination thereof). In some implementations, the processor 1302 may be configured to operate the memory 1304. In some other implementations, the memory 1304 may be integrated into the processor 1302. The processor 1302 may be configured to execute computer-readable instructions stored in the memory 1304 to cause the UE 1300 to perform various functions of the present disclosure.

The memory 1304 may include volatile or non-volatile memory. The memory 1304 may store computer-readable, computer-executable code including instructions when executed by the processor 1302 cause the UE 1300 to perform various functions described herein. The code may be stored in a non-transitory computer-readable medium such as the memory 1304 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 1302 and the memory 1304 coupled with the processor 1302 may be configured to cause the UE 1300 to perform one or more of the functions described herein (e.g., executing, by the processor 1302, instructions stored in the memory 1304). For example, the processor 1302 may support wireless communication at the UE 1300 in accordance with examples as disclosed herein. The UE 1300 may be configured to or operable to support a means for transmitting a first assistance request for power class reduction based at least in part on one or more of a UE power condition or a UE thermal condition.

Additionally, the UE 1300 may be configured to support any one or combination of where the first assistance request includes UE assistance information (UAI); the first assistance request is based at least in part on the UE power condition, and the UE power condition is based at least in part on a UE power mode; the first assistance request is based at least in part on the UE power condition, and the UE power condition is based at least in part on a UE battery level; the first assistance request is based at least in part on the UE power condition, and the UE power condition is based at least in part on an application power parameter; the first assistance request is based at least in part on the UE power condition, and the UE power condition is based at least in part on a channel quality; the first assistance request includes an indication of an uplink parameter associated with power class reduction; determining that one or more of the UE power condition or the UE thermal condition occurs; determining that one or more of a channel quality condition or an emergency condition occurs; and preventing transmission of a second assistance request for power class reduction based at least in part on one or more of the channel quality condition or the emergency condition; the first assistance request is based at least in part on an estimated power reduction value, and wherein the estimated power reduction value is based at least in part on an estimated power output reduction associated with the power class reduction.

Additionally, the UE 1300 may be configured to support any one or combination of where the estimated power output reduction is based at least in part on an estimated uplink power output reduction; the estimated power reduction value is based at least in part on a battery level value; the first assistance request is based at least in part on the UE thermal condition, and wherein the UE thermal condition includes one or more thermal thresholds; the first assistance request is based at least in part on the UE thermal condition, and the UE thermal condition is based at least in part on an application power parameter; the first assistance request is based at least in part on an estimated thermal reduction value, and wherein the estimated thermal reduction value is based at least in part on the power class reduction; the estimated thermal reduction value is based at least in part on an estimated reduction in uplink operation or an estimated reduction in downlink operation; generating the first assistance request via a machine learning algorithm trained with one or more of UE power condition data or UE thermal condition data; the first assistance request is selected from multiple candidate assistance requests identified by the machine learning algorithm.

Additionally, or alternatively, the UE 1300 may support at least one memory (e.g., the memory 1304) and at least one processor (e.g., the processor 1302) coupled with the at least one memory and configured to cause the UE to transmit a first assistance request for power class reduction based at least in part on one or more of a UE power condition or a UE thermal condition.

Additionally, the UE 1300 may be configured to support any one or combination of where the first assistance request includes UE assistance information (UAI); the first assistance request is based at least in part on the UE power condition, and the UE power condition is based at least in part on a UE power mode; the first assistance request is based at least in part on the UE power condition, and the UE power condition is based at least in part on a UE battery level; the first assistance request is based at least in part on the UE power condition, and the UE power condition is based at least in part on an application power parameter; the first assistance request is based at least in part on the UE power condition, and the UE power condition is based at least in part on a channel quality; the first assistance request includes an indication of an uplink parameter associated with power class reduction; the at least one processor is operable to cause the UE to: determine that one or more of the UE power condition or the UE thermal condition occurs; determine that one or more of a channel quality condition or an emergency condition occurs; and prevent transmission of a second assistance request for power class reduction based at least in part on one or more of the channel quality condition or the emergency condition; the first assistance request is based at least in part on an estimated power reduction value, and wherein the estimated power reduction value is based at least in part on an estimated power output reduction associated with the power class reduction.

Additionally, the UE 1300 may be configured to support any one or combination of where the estimated power output reduction is based at least in part on an estimated uplink power output reduction; the estimated power reduction value is based at least in part on a battery level value; the first assistance request is based at least in part on the UE thermal condition, and wherein the UE thermal condition includes one or more thermal thresholds; the first assistance request is based at least in part on the UE thermal condition, and the UE thermal condition is based at least in part on an application power parameter; the first assistance request is based at least in part on an estimated thermal reduction value, and wherein the estimated thermal reduction value is based at least in part on the power class reduction; the estimated thermal reduction value is based at least in part on an estimated reduction in uplink operation or an estimated reduction in downlink operation; the at least one processor is operable to cause the UE to generate the first assistance request via a machine learning algorithm trained with one or more of UE power condition data or UE thermal condition data; the first assistance request is selected from multiple candidate assistance requests identified by the machine learning algorithm.

The controller 1306 may manage input and output signals for the UE 1300. The controller 1306 may also manage peripherals not integrated into the UE 1300. In some implementations, the controller 1306 may utilize an operating system such as iOS®, ANDROID®, WINDOWS®, or other operating systems. In some implementations, the controller 1306 may be implemented as part of the processor 1302.

In some implementations, the UE 1300 may include at least one transceiver 1308. In some other implementations, the UE 1300 may have more than one transceiver 1308. The transceiver 1308 may represent a wireless transceiver. The transceiver 1308 may include one or more receiver chains 1310, one or more transmitter chains 1312, or a combination thereof.

A receiver chain 1310 may be configured to receive signals (e.g., control information, data, packets) over a wireless medium. For example, the receiver chain 1310 may include one or more antennas to receive a signal over the air or wireless medium. The receiver chain 1310 may include at least one amplifier (e.g., a low-noise amplifier (LNA)) configured to amplify the received signal. The receiver chain 1310 may include at least one demodulator configured to demodulate the receive signal and obtain the transmitted data by reversing the modulation technique applied during transmission of the signal. The receiver chain 1310 may include at least one decoder for decoding the demodulated signal to receive the transmitted data.

A transmitter chain 1312 may be configured to generate and transmit signals (e.g., control information, data, packets). The transmitter chain 1312 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 1312 may also include at least one power amplifier configured to amplify the modulated signal to an appropriate power level suitable for transmission over the wireless medium. The transmitter chain 1312 may also include one or more antennas for transmitting the amplified signal into the air or wireless medium.

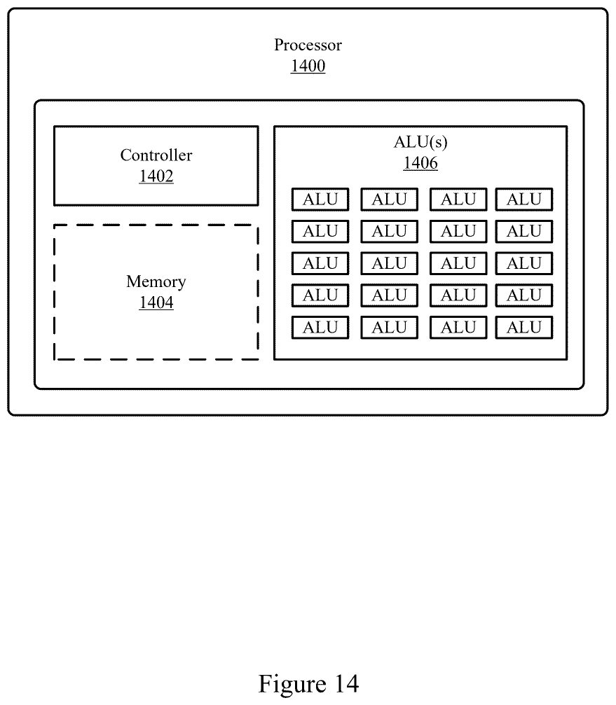

FIG. 14 illustrates an example of a processor 1400 in accordance with aspects of the present disclosure. The processor 1400 may be an example of a processor configured to perform various operations in accordance with examples as described herein. The processor 1400 may include a controller 1402 configured to perform various operations in accordance with examples as described herein. The processor 1400 may optionally include at least one memory 1404, which may be, for example, an L1/L2/L3 cache. Additionally, or alternatively, the processor 1400 may optionally include one or more arithmetic-logic units (ALUs) 1406. One or more of these components may be in electronic communication or otherwise coupled (e.g., operatively, communicatively, functionally, electronically, electrically) via one or more interfaces (e.g., buses).

The processor 1400 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 1400) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 1402 may be configured to manage and coordinate various operations (e.g., signaling, receiving, obtaining, retrieving, transmitting, outputting, forwarding, storing, determining, identifying, accessing, writing, reading) of the processor 1400 to cause the processor 1400 to support various operations in accordance with examples as described herein. For example, the controller 1402 may operate as a control unit of the processor 1400, generating control signals that manage the operation of various components of the processor 1400. These control signals include enabling or disabling functional units, selecting data paths, initiating memory access, and coordinating timing of operations.

The controller 1402 may be configured to fetch (e.g., obtain, retrieve, receive) instructions from the memory 1404 and determine subsequent instruction(s) to be executed to cause the processor 1400 to support various operations in accordance with examples as described herein. The controller 1402 may be configured to track memory addresses of instructions associated with the memory 1404. The controller 1402 may be configured to decode instructions to determine the operation to be performed and the operands involved. For example, the controller 1402 may be configured to interpret the instruction and determine control signals to be output to other components of the processor 1400 to cause the processor 1400 to support various operations in accordance with examples as described herein. Additionally, or alternatively, the controller 1402 may be configured to manage flow of data within the processor 1400. The controller 1402 may be configured to control transfer of data between registers, ALUs 1406, and other functional units of the processor 1400.

The memory 1404 may include one or more caches (e.g., memory local to or included in the processor 1400 or other memory, such as RAM, ROM, DRAM, SDRAM, SRAM, MRAM, flash memory, etc. In some implementations, the memory 1404 may reside within or on a processor chipset (e.g., local to the processor 1400). In some other implementations, the memory 1404 may reside external to the processor chipset (e.g., remote to the processor 1400).

The memory 1404 may store computer-readable, computer-executable code including instructions that, when executed by the processor 1400, cause the processor 1400 to perform various functions described herein. The code may be stored in a non-transitory computer-readable medium such as system memory or another type of memory. The controller 1402 and/or the processor 1400 may be configured to execute computer-readable instructions stored in the memory 1404 to cause the processor 1400 to perform various functions. For example, the processor 1400 and/or the controller 1402 may be coupled with or to the memory 1404, the processor 1400, and the controller 1402, and may be configured to perform various functions described herein. In some examples, the processor 1400 may include multiple processors and the memory 1404 may include multiple memories. One or more of the multiple processors may be coupled with one or more of the multiple memories, which may, individually or collectively, be configured to perform various functions herein.

The one or more ALUs 1406 may be configured to support various operations in accordance with examples as described herein. In some implementations, the one or more ALUs 1406 may reside within or on a processor chipset (e.g., the processor 1400). In some other implementations, the one or more ALUs 1406 may reside external to the processor chipset (e.g., the processor 1400). One or more ALUs 1406 may perform one or more computations such as addition, subtraction, multiplication, and division on data. For example, one or more ALUs 1406 may receive input operands and an operation code, which determines an operation to be executed. One or more ALUs 1406 may be configured with a variety of logical and arithmetic circuits, including adders, subtractors, shifters, and logic gates, to process and manipulate the data according to the operation. Additionally, or alternatively, the one or more ALUs 1406 may support logical operations such as AND, OR, exclusive-OR (XOR), not-OR (NOR), and not-AND (NAND), enabling the one or more ALUs 1406 to handle conditional operations, comparisons, and bitwise operations.

The processor 1400 may support wireless communication in accordance with examples as disclosed herein. The processor 1400 may be configured to or operable to support at least one controller (e.g., the controller 1402) coupled with at least one memory (e.g., the memory 1404) and configured to cause the processor to transmit a first assistance request for power class reduction based at least in part on one or more of a UE power condition or a UE thermal condition.

Additionally, the processor 1400 may be configured to or operable to support any one or combination of where the first assistance request includes UE assistance information (UAI); the first assistance request is based at least in part on the UE power condition, and the UE power condition is based at least in part on a UE power mode; the first assistance request is based at least in part on the UE power condition, and the UE power condition is based at least in part on a UE battery level; the first assistance request is based at least in part on the UE power condition, and the UE power condition is based at least in part on an application power parameter; the first assistance request is based at least in part on the UE power condition, and the UE power condition is based at least in part on a channel quality; the first assistance request includes an indication of an uplink parameter associated with power class reduction; the at least one controller is operable to cause the processor to: determine that one or more of the UE power condition or the UE thermal condition occurs; determine that one or more of a channel quality condition or an emergency condition occurs; and prevent transmission of a second assistance request for power class reduction based at least in part on one or more of the channel quality condition or the emergency condition; the first assistance request is based at least in part on an estimated power reduction value, and wherein the estimated power reduction value is based at least in part on an estimated power output reduction associated with the power class reduction.

Additionally, the processor 1400 may be configured to or operable to support any one or combination of where the estimated power output reduction is based at least in part on an estimated uplink power output reduction; the estimated power reduction value is based at least in part on a battery level value; the first assistance request is based at least in part on the UE thermal condition, and wherein the UE thermal condition includes one or more thermal thresholds; the first assistance request is based at least in part on the UE thermal condition, and the UE thermal condition is based at least in part on an application power parameter; the first assistance request is based at least in part on an estimated thermal reduction value, and wherein the estimated thermal reduction value is based at least in part on the power class reduction; the estimated thermal reduction value is based at least in part on an estimated reduction in uplink operation or an estimated reduction in downlink operation; the at least one controller is operable to cause the processor to generate the first assistance request via a machine learning algorithm trained with one or more of UE power condition data or UE thermal condition data; the first assistance request is selected from multiple candidate assistance requests identified by the machine learning algorithm.

The processor 1400 may support wireless communication in accordance with examples as disclosed herein. The processor 1400 may be configured to or operable to support at least one controller (e.g., the controller 1402) coupled with at least one memory (e.g., the memory 1404) and configured to cause the processor to receive a first assistance request for power class reduction based at least in part on one or more of a UE power condition or a UE thermal condition; and perform a power class reduction operation based at least in part on the first assistance request.

Additionally, the processor 1400 may be configured to or operable to support any one or combination of where the first assistance request includes UE assistance information (UAI); the first assistance request includes an indication of an uplink parameter associated with power class reduction.

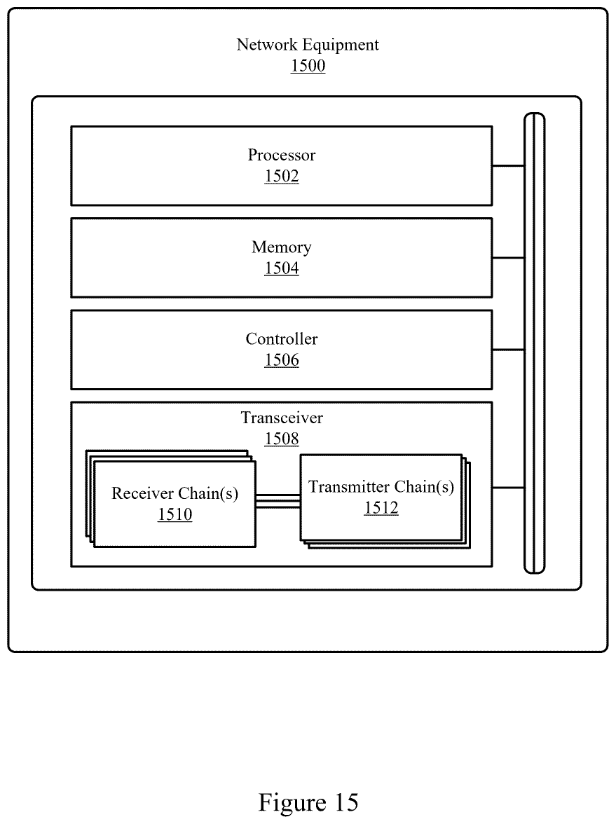

FIG. 15 illustrates an example of an NE 1500 in accordance with aspects of the present disclosure. The NE 1500 may include a processor 1502, a memory 1504, a controller 1506, and a transceiver 1508. The processor 1502, the memory 1504, the controller 1506, or the transceiver 1508, or various combinations thereof or various components thereof may be examples of means for performing various aspects of the present disclosure as described herein. These components may be coupled (e.g., operatively, communicatively, functionally, electronically, electrically) via one or more interfaces.

The processor 1502, the memory 1504, the controller 1506, or the transceiver 1508, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 1502 may include an intelligent hardware device (e.g., a general-purpose processor, a DSP, a CPU, an ASIC, an FPGA, or any combination thereof). In some implementations, the processor 1502 may be configured to operate the memory 1504. In some other implementations, the memory 1504 may be integrated into the processor 1502. The processor 1502 may be configured to execute computer-readable instructions stored in the memory 1504 to cause the NE 1500 to perform various functions of the present disclosure.

The memory 1504 may include volatile or non-volatile memory. The memory 1504 may store computer-readable, computer-executable code including instructions when executed by the processor 1502 cause the NE 1500 to perform various functions described herein. The code may be stored in a non-transitory computer-readable medium such as the memory 1504 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 1502 and the memory 1504 coupled with the processor 1502 may be configured to cause the NE 1500 to perform one or more of the functions described herein (e.g., executing, by the processor 1502, instructions stored in the memory 1504). For example, the processor 1502 may support wireless communication at the NE 1500 in accordance with examples as disclosed herein. The NE 1500 may be configured to or operable to support a means for receiving a first assistance request for power class reduction based at least in part on one or more of a UE power condition or a UE thermal condition; and performing a power class reduction operation based at least in part on the first assistance request.

Additionally, the NE 1500 may be configured to or operable to support any one or combination of where the first assistance request includes UE assistance information (UAI); the first assistance request includes an indication of an uplink parameter associated with power class reduction.

Additionally, or alternatively, the NE 1500 may support at least one memory (e.g., the memory 1504) and at least one processor (e.g., the processor 1502) coupled with the at least one memory and configured to cause the NE to receive a first assistance request for power class reduction based at least in part on one or more of a UE power condition or a UE thermal condition; and perform a power class reduction operation based at least in part on the first assistance request.

Additionally, the NE 1500 may be configured to support any one or combination of where the first assistance request includes UE assistance information (UAI); the first assistance request includes an indication of an uplink parameter associated with power class reduction.

The controller 1506 may manage input and output signals for the NE 1500. The controller 1506 may also manage peripherals not integrated into the NE 1500. In some implementations, the controller 1506 may utilize an operating system such as iOS®, ANDROID®, WINDOWS®, or other operating systems. In some implementations, the controller 1506 may be implemented as part of the processor 1502.

In some implementations, the NE 1500 may include at least one transceiver 1508. In some other implementations, the NE 1500 may have more than one transceiver 1508. The transceiver 1508 may represent a wireless transceiver. The transceiver 1508 may include one or more receiver chains 1510, one or more transmitter chains 1512, or a combination thereof.

A receiver chain 1510 may be configured to receive signals (e.g., control information, data, packets) over a wireless medium. For example, the receiver chain 1510 may include one or more antennas to receive a signal over the air or wireless medium. The receiver chain 1510 may include at least one amplifier (e.g., a low-noise amplifier (LNA)) configured to amplify the received signal. The receiver chain 1510 may include at least one demodulator configured to demodulate the receive signal and obtain the transmitted data by reversing the modulation technique applied during transmission of the signal. The receiver chain 1510 may include at least one decoder for decoding the demodulated signal to receive the transmitted data.

A transmitter chain 1512 may be configured to generate and transmit signals (e.g., control information, data, packets). The transmitter chain 1512 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 1512 may also include at least one power amplifier configured to amplify the modulated signal to an appropriate power level suitable for transmission over the wireless medium. The transmitter chain 1512 may also include one or more antennas for transmitting the amplified signal into the air or wireless medium.

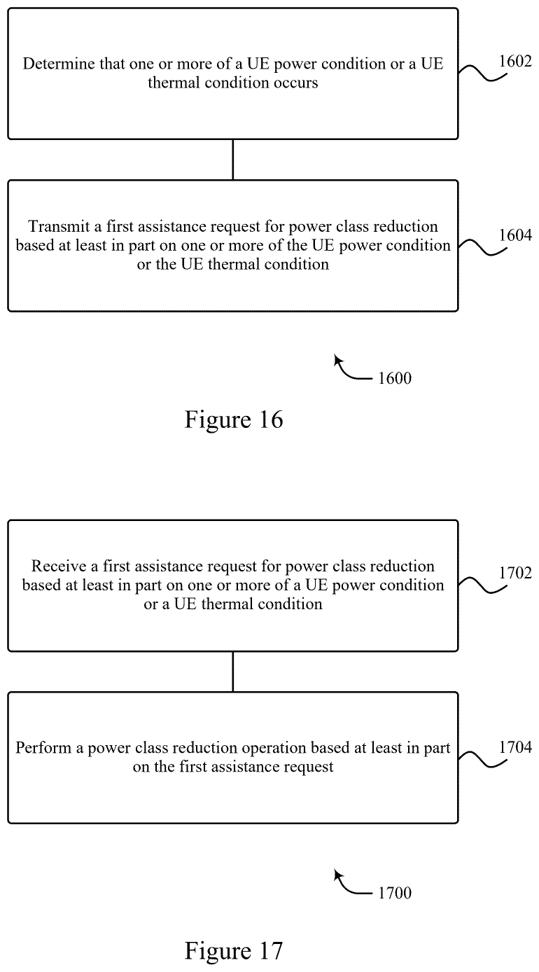

FIG. 16 illustrates a flowchart of a method 1600 in accordance with aspects of the present disclosure. The operations of the method may be implemented by a UE as described herein. In some implementations, the UE may execute a set of instructions to control the function elements of the UE to perform the described functions. It should be noted that the method described herein describes a possible implementation, and that the operations and the steps may be rearranged or otherwise modified and that other implementations are possible.

At 1602, the method may include determining that one or more of a UE power condition or a UE thermal condition occurs. The operations of 1602 may be performed in accordance with examples as described herein. In some implementations, aspects of the operations of 1602 may be performed by a UE as described with reference to FIG. 13.

At 1604, the method may include transmitting a first assistance request for power class reduction based at least in part on one or more of the UE power condition or the UE thermal condition. The operations of 1604 may be performed in accordance with examples as described herein. In some implementations, aspects of the operations of 1604 may be performed by a UE as described with reference to FIG. 13.

FIG. 17 illustrates a flowchart of a method 1700 in accordance with aspects of the present disclosure. The operations of the method may be implemented by an NE as described herein. In some implementations, the NE may execute a set of instructions to control the function elements of the NE to perform the described functions. It should be noted that the method described herein describes a possible implementation, and that the operations and the steps may be rearranged or otherwise modified and that other implementations are possible.

At 1702, the method may include receiving a first assistance request for power class reduction based at least in part on one or more of a UE power condition or a UE thermal condition. The operations of 1702 may be performed in accordance with examples as described herein. In some implementations, aspects of the operations of 1702 may be performed by an NE as described with reference to FIG. 15.

At 1704, the method may include performing a power class reduction operation based at least in part on the first assistance request. The operations of 1704 may be performed in accordance with examples as described herein. In some implementations, aspects of the operations of 1704 may be performed by an NE as described with reference to FIG. 15.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE) for wireless communication, comprising:
at least one memory; and
at least one processor coupled with the at least one memory and operable to cause the UE to:
transmit a first assistance request for power class reduction based at least in part on one or more of a UE power condition or a UE thermal condition.

2. The UE of claim 1, wherein the first assistance request comprises UE assistance information (UAI).

3. The UE of claim 1, wherein the first assistance request is based at least in part on the UE power condition, and the UE power condition is based at least in part on a UE power mode.

4. The UE of claim 1, wherein the first assistance request is based at least in part on the UE power condition, and the UE power condition is based at least in part on a UE battery level.

5. The UE of claim 1, wherein the first assistance request is based at least in part on the UE power condition, and the UE power condition is based at least in part on an application power parameter.

6. The UE of claim 1, wherein the first assistance request is based at least in part on the UE power condition, and the UE power condition is based at least in part on a channel quality.

7. The UE of claim 1, wherein the first assistance request comprises an indication of an uplink parameter associated with power class reduction.

8. The UE of claim 1, wherein the at least one processor is operable to cause the UE to:
determine that one or more of the UE power condition or the UE thermal condition occurs;
determine that one or more of a channel quality condition or an emergency condition occurs; and
prevent transmission of a second assistance request for power class reduction based at least in part on one or more of the channel quality condition or the emergency condition.

9. The UE of claim 1, wherein the first assistance request is based at least in part on an estimated power reduction value, and wherein the estimated power reduction value is based at least in part on an estimated power output reduction associated with the power class reduction.

10. The UE of claim 9, wherein the estimated power output reduction is based at least in part on an estimated uplink power output reduction.

11. The UE of claim 9, wherein the estimated power reduction value is based at least in part on a battery level value.

12. The UE of claim 1, wherein the first assistance request is based at least in part on the UE thermal condition, and wherein the UE thermal condition comprises one or more thermal thresholds.

13. The UE of claim 1, wherein the first assistance request is based at least in part on the UE thermal condition, and the UE thermal condition is based at least in part on an application power parameter.

14. The UE of claim 1, wherein the first assistance request is based at least in part on an estimated thermal reduction value, and wherein the estimated thermal reduction value is based at least in part on the power class reduction.

15. The UE of claim 14, wherein the estimated thermal reduction value is based at least in part on an estimated reduction in uplink operation or an estimated reduction in downlink operation.

16. The UE of claim 1, wherein the at least one processor is operable to cause the UE to generate the first assistance request via a machine learning algorithm trained with one or more of UE power condition data or UE thermal condition data.

17. The UE of claim 16, wherein the first assistance request is selected from multiple candidate assistance requests identified by the machine learning algorithm.

18. A network equipment (NE) for wireless communication, comprising:
at least one memory; and
at least one processor coupled with the at least one memory and operable to cause the NE to:
receive a first assistance request for power class reduction based at least in part on one or more of a user equipment (UE) power condition or a UE thermal condition; and
perform a power class reduction operation based at least in part on the first assistance request.

19. A method performed by a user equipment (UE), the method comprising:
transmitting a first assistance request for power class reduction based at least in part on one or more of a UE power condition or a UE thermal condition.

20. A method performed by a network equipment (NE), the method comprising:
receiving a first assistance request for power class reduction based at least in part on one or more of a user equipment (UE) power condition or a UE thermal condition; and
performing a power class reduction operation based at least in part on the first assistance request.
